(19) United States
(12) Patent Application Publication
(10) Pub. No.: US 2013/0219011 A1
(43) Pub. Date: Aug. 22, 2013

(54) SYSTEM AND METHOD FOR PROVIDING PATIENT RELATIONSHIP MANAGEMENT

(71) Applicant: Rob F. White, Charleston, WV (US)

(72) Inventor: Rob F. White, Charleston, WV (US)

(73) Assignee: EHRSOLUTIONS, LLC, Charleston, WV (US)

(21) Appl. No.: 13/400,904

(22) Filed: Feb. 21, 2012

(51) Int. Cl. G06F 15/16

(52) U.S. Cl. 709/217

(57) ABSTRACT

The present invention generally relates to relationship management systems. In particular, embodiments of the invention relate to a computer implemented system and method for managing, building, controlling and organizing relationships between service consumers and service providers. In a preferred embodiment, the system is configured to manage, build, control and/or organize relationships between patients and providers of healthcare services.

### FIELD OF THE INVENTION

The present invention generally relates to relationship management systems. In particular, embodiments of the invention relate to a computer implemented system and method for managing, building, controlling and organizing relationships between service consumers and service providers. In a preferred embodiment, the system is configured to manage, build, control and/or organize relationships between patients and providers of healthcare services.

### BACKGROUND

Businesses in many industries have long utilized customer relationship management systems to help manage interactions with customers, clients and sales prospects. These systems typically are focused on automating and synchronizing business processes, such as sales activities, marketing, customer service and technical support. Generally, the goal is to find, attract and convert new clients as well as tend the relationships the company already has and entice previous clientele back. The underlying purpose of these systems is to reduce the cost of marketing and client service.

While many industries have utilized customer relationship management systems, certain have failed to effectively utilize and develop customer relationship management systems due to constraints or complications in particular industries. For instance, in the healthcare industry, use of customer relationship management systems is either limited in scope or altogether non-existent.

One reason for the lack of use and proliferation with respect to healthcare oriented customer relationship management systems is that there are numerous concerns with respect to the sensitive nature of the information related to the provision and maintenance of healthcare services. Unauthorized use or disclosure of certain types of information relating to patients or other users of healthcare systems can result in significant legal and/or financial ramifications.

Another complexity of with utilizing customer relationship management systems in the healthcare industry is the complex and numerous variety of events that must be managed and automated by these systems. Currently, no system available is capable of managing the wide variety of events associated with the healthcare industry.

Yet another complexity of utilizing customer relationship management systems in the healthcare industry that the industry itself is so fragmented. A patient may need to see multiple doctors or other providers at various locations for a single condition. In this manner, it is complicated to provide a system that is able to manage the entirety of a patient's care over a widespread network of doctors and providers.

Additionally, no customer relationship management system currently available is capable of providing and automating the plurality of delivery methods required for the various types of contact made by providers of healthcare systems. It is not enough for a customer relationship management system to be able to communicate only by e-mail or automated dialing methods.

Finally, given the fluidity of the healthcare industry, there is need for a customer relationship management system that can handle constantly changing scheduling routines in a manner that efficiently fills openings and cancellations as they appear. Currently, no customer relationship management system is able to handle this concern.

Therefore, there is need in the art for a customer relationship management system capable of managing, building, controlling and organizing relationships between service consumers and service providers in complex industries, such as the healthcare industry. These and other features and advantages of the present invention will be explained and will become obvious to one skilled in the art through the summary of the invention that follows.

### SUMMARY OF THE INVENTION

Accordingly, it is an aspect of the present invention to provide a customer relationship management system capable of managing, building, controlling and organizing relationships between service consumers and service providers in complex industries, such as the healthcare industry.

According to an embodiment of the present invention, a computer implemented system for providing customer relationship management includes a rules engine comprising computer-executable code stored in non-volatile memory, a data store and a rules engine communications means; a communications engine comprising computer-executable code stored in non-volatile memory and a communications engine communications means, wherein the rules engine communications means is configured to communicate data to the communications engine communications means; and one or more delivery engines comprising computer-executable code stored in non-volatile memory, one or more delivery means and a delivery engine communications means, wherein the communications engine communications means is configured to communicate data to the delivery engine communications means of the one or more delivery engines, wherein the rules engine is configured to transmit event information, via the rules engine communications means to the communications engine communications means, wherein the communications engine is configured to communicate the event information to one or more of the one or more delivery engines, and wherein each of the one or more delivery means receiving the event information is configured to process the event information into a processed event and effect delivery of the processed event.

According to an embodiment of the present invention, the event information includes information related to an individual.

According to an embodiment of the present invention, the communications engine communications means is configured to communicate data to the rules engine communications means.

According to an embodiment of the present invention, at least one of the delivery engine communications means is configured to communicate data to the communications engine communications means.

According to an embodiment of the present invention, at least one of the delivery engines communicates a delivery confirmation to the communications engine.

According to an embodiment of the present invention, the communications engine communicates the delivery confirmation to the rules engine.

According to an embodiment of the present invention, the rules engine processes the delivery confirmation and stores related data in the data store.

According to an embodiment of the present invention, a computer implemented method for providing patient relationship management includes the steps of receiving an event request at a rules engine comprising computer-executable code stored in non-volatile memory, a data store and a rules engine communications means; retrieving data associated with said event request from said data store; generating, at said rules engine, event information from said event request and said data associated with said event request; transmitting, via said rules engine communications means, said event information to a communications engine comprising computer-executable code stored in non-volatile memory and a communications engine communications means; receiving said event information at said communications engine communications means; determining, at said communications engine, one or more delivery engines to communicate said event information to, wherein each of said delivery engines comprises computer-executable code stored in non-volatile memory, one or more delivery means and a delivery engine communications means; transmitting, via said communications engine communications means, event information to one or more of said one or more delivery engines; processing, at one or more of said one or more delivery engines, said event information into a processed event; and delivering, via said one or more delivery means, said processed event.

According to an embodiment of the present invention, the event information includes information related to an individual.

According to an embodiment of the present invention, the method may include the step of communicating a delivery confirmation from one or more of the one or more delivery engines to the communications engine.

According to an embodiment of the present invention, the method may include the step of communicating the delivery confirmation from the communications engine to the rules engine.

According to an embodiment of the present invention, the method may include the step of processing the delivery confirmation.

According to an embodiment of the present invention, the method may include the step of storing the delivery confirmation in the data store.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3 is a schematic of a system, in accordance with an embodiment of the present invention;

FIG. 4 is a flowchart of an exemplary method in accordance with an embodiment of the present invention; and

FIG. 5 is a flowchart of an exemplary method in accordance with an embodiment of the present invention.

### DETAILED SPECIFICATION

The present invention generally relates to relationship management systems. In particular, embodiments of the invention relate to a computer implemented system and method for managing, building, controlling and organizing relationships between service consumers and service providers. In a preferred embodiment, the system is configured to manage, build, control and/or organize relationships between patients and providers of healthcare services.

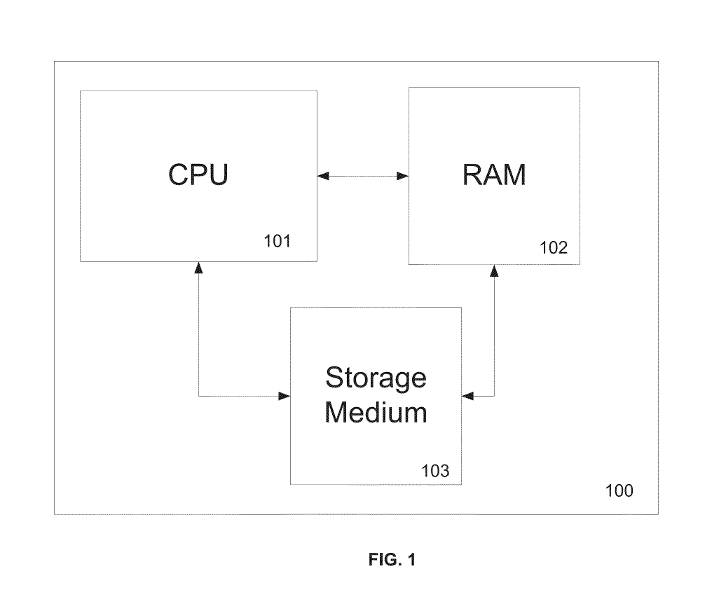

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, and a storage medium (e.g., hard disk drive, solid state drive, flash memory, cloud storage) 103. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

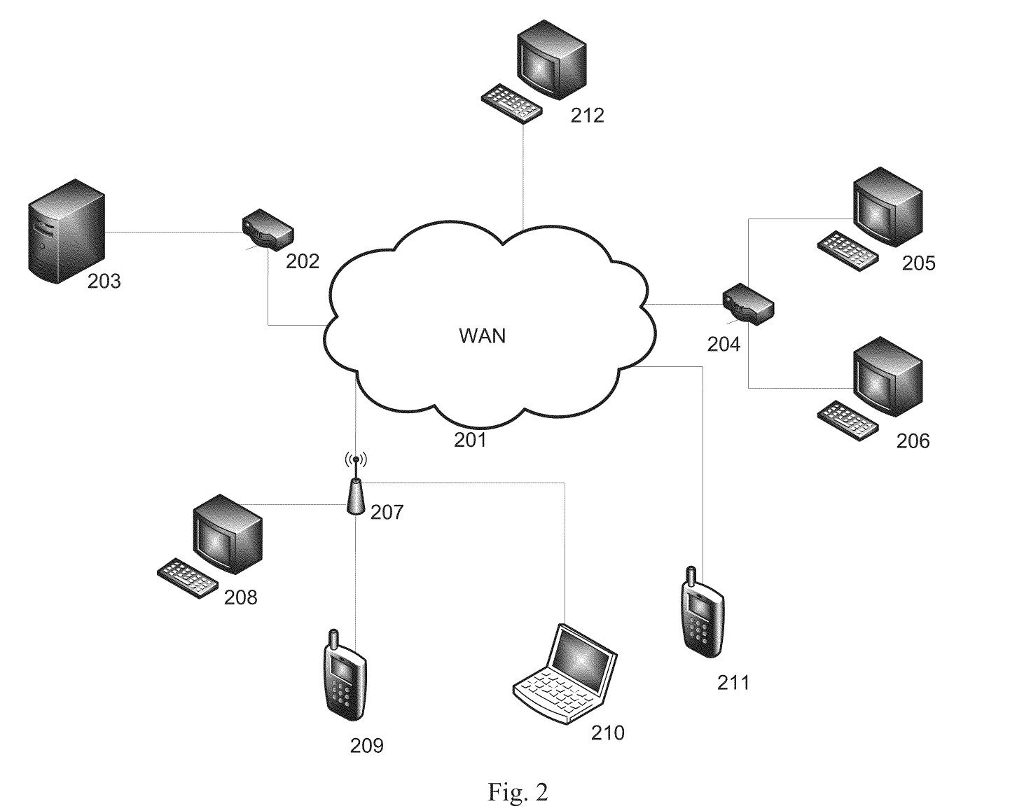

Referring to FIG. 2, a schematic overview of a system in accordance with an embodiment of the present invention is shown. The system is comprised of one or more application servers 203 for electronically storing information used by the system. Applications in the application server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

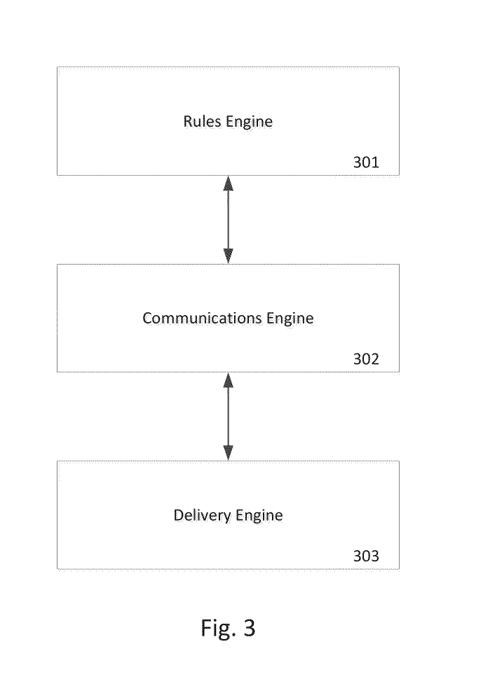

Turning to FIG. 3, a preferred embodiment of the present invention is shown. In this embodiment, the system is comprised of three main components: a rules engine 301; a communications engine 302; and a delivery engine 303. According to embodiments of the present invention, the rules engine 301, communications engine 302 and delivery engine 303 are communicatively connected across one or more computing devices. In a preferred embodiment, the rules engine 301 is present at a healthcare facility (e.g., hospital, doctor's office, physical therapy center) while the communications engine 302 and delivery engine 303 exist on one or more remote computing devices. However, in alternate embodiments, the present invention may be spread out over one or more locations, local or remote to the healthcare facility, with communications between the system and other computing devices occurring over one or more networks. One of ordinary skill in the art would appreciate that there are numerous configurations that could be utilized with embodiments of the present invention, and embodiments of the present invention are contemplated for use with any configuration. In certain embodiments, each of the aforementioned engines are communicatively connected to the others in one or more means. However, in a preferred embodiment, the communications engine 302 is communicatively connected to both the rules engine 301 and the delivery engine 303 and the communications engine 302 is configured to handle all communications between the rules engine 301 and delivery engine 303.

According to an embodiment of the present invention, the rules engine exists on a computing device and is configured to provide service providers the ability to perform a multitude of actions in relation to the patient relationship management system described herein. In particular, the rules engine is configured to allow the service provider to insert, change, modify, remove, update or otherwise manage various events and rules related to events with respect to the patient relationship management system. The rules engine may be accessible directly from the computing device the rules engine exists on, or remotely by way of logging into the rules engine through the use of another computing device. For instance, the rules engine may exist on a server computer at the service provider's facility and may be accessed by users utilizing other computing devices that are communicatively connected to the server.

According to an embodiment of the present invention, the rules engine may be further comprised of a data store. The data store may include any form of computing device capable of storing information and communicating with other computing devices, or may otherwise exist on the same computing device as the rules engine. For example and without limitation, in embodiments the data store includes a relational database management system, a stream-based database management system, or the like. A variety of suitable database management systems will be readily appreciated. The data store is operatively coupled to the rules engine.

The data store is configured to store information related to the service consumers of the service provider. In a preferred embodiment of the present invention, service consumers are patients and/or their respective authorized contacts, guardians or other individuals associated with their care. For convenience, the term patient(s) may be used to refer to this group of individuals in both an individual and collective manner. This may include, but is not limited to, patient health records, electronic health records, contact information, biographical information, authorized contacts, appropriate delivery methods and promotional information. One of ordinary skill in the art would appreciate that there are numerous forms of data that the data store could contain and embodiments of the present invention are contemplated for use with any form of data.

According to an embodiment of the present invention, once the service provider has setup one or more rules for the rules engine to process with respect to one or more patients, the rules engine automates the processing of these rules under the criteria set for each event identified and enabled by the service provider. Events may include, but are not limited to, appointments, birthdays, recalls, prescriptions, labs, orders, thank you notifications, general messages, surveys, immunizations, location updates, provider updates, medication reminders, refill reminders, disease management, follow-ups, procedures, collections, accounting statements, payment plans, tasks, births, wellness/preventative medicine and social correspondences. One of ordinary skill in the art would appreciate that there are numerous events that could be utilized with embodiments of the present invention, and embodiments of the present invention are envisioned for use with any type of event.

According to an embodiment of the present invention, once an event is ready to be processed/issued, the rules engine retrieves all relevant information for the event from the data store and processes the event into a formatted event package for communication to a communications engine.

According to an embodiment of the present invention, the communications engine exists on one or more computing devices and is configured to receive event information from a rules engine and determine one or more delivery engines that are intended recipients of said event information. In this manner, the communications engine acts as a conduit for transmitting event information to one or more delivery engines for delivery to the appropriate recipients.

In a preferred embodiment, the communications engine exists on a server remote from the rules engine. In this manner, a single server or cluster of servers may direct the communications of numerous rules engines. Further, this allows for networks of service providers with individual rules engines to be served jointly through networked communications engine. This is extremely advantageous when multiple service providers have integrated interests, such as shared care for an individual patient.

According to an embodiment of the present invention, the system if further comprised of one or more delivery engines, configured to receive event information. The delivery engines exist on one or more computing devices and are configured to receive event information from the communications engine and process the event information into appropriate format for delivery. Delivery engines are configured to deliver the event information through one or more delivery means. Delivery means include, but are not limited to, e-mail, secured email, text, SMS, multimedia communications, voice, voicemail, printed communications (e.g., brochures, appointment cards, notices), social media communications (e.g., tweets, Facebook posts) and calendar reminders. One of ordinary skill in the art would appreciate that there are numerous delivery means that could be utilized with embodiments of the present invention and embodiments of the present invention are contemplated for use with any delivery means. A single delivery engine may be configured to deliver multiple types of content via one or more delivery means. Alternatively, one or more delivery engines may be utilized, where each delivery engine is configured to deliver one or more content types via one or more delivery means. One of ordinary skill in the art would appreciate that there are numerous configurations of delivery engines that could be utilized with embodiments of the present invention, and embodiments of the present invention are contemplated for use with any configuration of delivery engines.

According to an embodiment of the present invention, the delivery engines are configured to process delivery automatically. In this manner, the entire process, from rules engine to delivery engine, is automated once the appropriate rules have been adopted and put in place by the service provider. Advantageously, the service provider is provided with fully automated patient relationship management without requirement for interaction. This frees up time for the service provider to focus on the provision of services to their patients.

According to an embodiment of the present invention, the system may be further configured to allow for the addition of promotional content to be utilized with the delivery of events. As service providers will have a myriad of information regarding their patients, appropriate promotional content for each patient allows may be specifically tailored and delivered with each event or selected specific events. For instance, an event sent to a patient reminding them that their prescription may be up for refill soon can be attached with promotional content associated with a generic brand of the drug the patient needs to refill. The possibilities for associating promotions with patients based on event information is endless, from promoting diapers and formulas to new mothers to new therapeutic methods and services provided by the provider to patients with existing conditions. One of ordinary skill in the art would appreciate that there are numerous types of promotional materials that could be identified and delivered with events in accordance with embodiments of the present invention, and embodiments of the present invention are contemplated for use with any type of promotional materials.

Event Types

Appointments

According to an embodiment of the present invention, the system is configured to provide appointment events. In this manner, providers can send pre and post-appointment notifications to patients and/or authorized contacts (e.g., parents of minors, guardians) with appointment information (e.g., date/time) and instructions (e.g., bring your patient packet).

According to embodiments of the present invention, the rules engine can be configured by a provider to allow for single or multiple notifications, in real time or at predefined time(s). In this manner, the system allows the provider to manage the content and schedule of appointment events. The system is further configured to allow the provider to select the delivery method, account balances, and content (e.g., audio, visual, data) for each appointment event notification. One of ordinary skill in the art would appreciate that there are numerous forms of content that may be utilized with embodiments of the present invention and embodiments of the present invention are contemplated for use with any type of content.

According to an embodiment of the present invention, the system is configured to provide the patient and/or authorized contact the ability to respond to appointment events. In a preferred embodiment, the patient may respond via the same delivery method as received by the patient and the system is configured to process the response from the patient and effect any changes necessary in the rules engine or related data store. For instance, if a patient receives a sms message from the system regarding an opening in the service provider's schedule, the patient may respond via sms to claim the opening. In this example, the sms would be received via the delivery engine that sent the sms message and the delivery engine would process the data received and send the information to the communications engine that would in turn communicate the data to the rules engine for processing and potential storage at the data store.

According to an embodiment of the present invention, with respect to appointment opening events, such as when a first patient cancels a scheduled appointment, thereby causing an opening in the service provider's schedule, the system may be configured to send out appointment opening events to one or more other patients that were awaiting an open appointment with the service provider. In a preferred embodiment, the system is configured to send out a limited number of appointment opening events at a time, waiting a specified amount of time to allow the patients contacted by the system the ability to respond before contacting the next patient in line. The order with which patients are sent events in this manner may be done at random, by priority rating, by manual selection or any combination thereof.

According to an embodiment of the present invention, the system may be configured to send promotional content along with appointment events. In this manner, patients can be provided with relevant promotional materials when receiving these events.

Birthdays

According to an embodiment of the present invention, the system is configured to send birthday greetings (i.e., birthday events) to patients and/or authorized contacts. Providers can configure the system, via the rules engine, to select the delivery method, age, sex, and content for each greeting. Patients will have the ability to respond.

According to an embodiment of the present invention, the system may be configured to send promotional content along with appointment events. In this manner, patients can be provided with relevant promotional materials when receiving these events.

Recalls

According to an embodiment of the present invention, the system may be configured to send recall notifications to patients and/or authorized contacts. Providers can utilize the system to send single or multiple notifications in real time or at predefined times (e.g., reoccurring until response received from the patient where the recall may significantly impact the patient's health). The system can be configured to deliver the event and content and patients will have the ability to respond as previously described herein.

According to an embodiment of the present invention, the system may be configured to send promotional content along with recall events. In this manner, patients can be provided with relevant promotional materials when receiving these events. For instance, a promotion for comparable replacement goods/services/medicines may be delivered with the recall event.

Prescriptions

According to an embodiment of the present invention, the system can send notifications to patients and/or authorized contacts when a prescription is prescribed or refilled. The system may be configured to send single or multiple notifications in real time or at predefined times (e.g., when a prescription is due to be refilled based on use). The system can be configured to deliver the event and content and patients will have the ability to respond as previously described herein.

According to an embodiment of the present invention, the system may be configured to send promotional content along with prescription events. In this manner, patients can be provided with relevant promotional materials when receiving these events. As described above, promotional materials for prescription invents may include promotions for alternatives, generics or other goods/services related to the prescription.

Labs

According to an embodiment of the present invention, the system can send notifications to patients and/or authorized contacts when lab results have been received or are required (e.g., yearly blood work). The system may be configured to send single or multiple notifications in real time or at predefined times. The system can be configured to deliver the event and content and patients will have the ability to respond as previously described herein. In the case where lab results require a follow-up visit with the service provider, the patient may be given the opportunity to select one or more open appointments so that they may visit and speak with their service provider. In this embodiment, the labs event may be associated with one or more appointment events as well (described above).

According to an embodiment of the present invention, the system may be configured to send promotional content along with labs events. In this manner, patients can be provided with relevant promotional materials when receiving these events.

Orders

According to an embodiment of the present invention, the system can send notifications to patients and/or authorized contacts when medical orders have been generated. The system may be configured to send single or multiple notifications in real time or at predefined times. The system can be configured to deliver the event and content and patients will have the ability to respond as previously described herein.

According to an embodiment of the present invention, the system may be configured to send promotional content along with order events. In this manner, patients can be provided with relevant promotional materials when receiving these events.

Thank You

According to an embodiment of the present invention, the system can send thank you notifications to patients and/or authorized contacts. The system may be configured to send single or multiple notifications in real time or at predefined times. The system can be configured to deliver the event and content and patients will have the ability to respond as previously described herein.

According to an embodiment of the present invention, the system may be configured to send promotional content along with thank you events. In this manner, patients can be provided with relevant promotional materials when receiving these events.

General Messages

According to an embodiment of the present invention, the system can send notifications to patients and/or authorized contacts. The system may be configured to send single or multiple notifications in real time or at predefined times. The system can be configured to deliver the event and content and patients will have the ability to respond as previously described herein. Example of general message events include, but are not limited to, office closings, changes in office hours, general news, general advice (e.g., flu season approaching) and messages from the service provider. One of ordinary skill in the art would appreciate that there are numerous types of general messages that may be utilized with embodiments of the present invention, and embodiments of the present invention are contemplated for use with any type of message.

According to an embodiment of the present invention, the system may be configured to send promotional content along with general message events. In this manner, patients can be provided with relevant promotional materials when receiving these events.

According to an embodiment of the present invention, the system can send notifications to patients and/or authorized contacts in bulk. In this manner, the system may be configured to accept a single event request from a user, where the event is to be delivered to one or more recipients. In this manner, events, like office closings, can be sent to multiple recipients easily and conveniently.

Survey

According to an embodiment of the present invention, the system can send patient surveys to patients and/or authorized contacts. The system may be configured to send single or multiple notifications in real time or at predefined times. The system can be configured to deliver the event and content and patients will have the ability to respond as previously described herein.

According to an embodiment of the present invention, the system may be configured to send promotional content along with survey events. In this manner, patients can be provided with relevant promotional materials when receiving these events.

Flu Shot

According to an embodiment of the present invention, the system can send announcements regarding flu shots to patients and/or authorized contacts. The system may be configured to send single or multiple notifications in real time or at predefined times. The system can be configured to deliver the event and content and patients will have the ability to respond as previously described herein.

According to an embodiment of the present invention, the system may be configured to send promotional content along with flu shot events. In this manner, patients can be provided with relevant promotional materials when receiving these events.

Immunizations

According to an embodiment of the present invention, the system can send notifications regarding immunizations to patients and/or authorized contacts. The system may be configured to send single or multiple notifications in real time or at predefined times. The system can be configured to deliver the event and content and patients will have the ability to respond as previously described herein.

According to an embodiment of the present invention, the system may be configured to send promotional content along with immunization events. In this manner, patients can be provided with relevant promotional materials when receiving these events.

Location Addition

According to an embodiment of the present invention, the system can send notifications regarding new practice locations to patients and/or authorized contacts. The system may be configured to send single or multiple notifications in real time or at predefined times. The system can be configured to deliver the event and content and patients will have the ability to respond as previously described herein.

According to an embodiment of the present invention, the system may be configured to send promotional content along with location addition events. In this manner, patients can be provided with relevant promotional materials when receiving these events.

Location Move

According to an embodiment of the present invention, the system can send notifications regarding the practice moving to patients and/or authorized contacts. The system may be configured to send single or multiple notifications in real time or at predefined times. The system can be configured to deliver the event and content and patients will have the ability to respond as previously described herein.

According to an embodiment of the present invention, the system may be configured to send promotional content along with location move events. In this manner, patients can be provided with relevant promotional materials when receiving these events.

Provider Joining

According to an embodiment of the present invention, the system can send notifications regarding new providers to patients and/or authorized contacts. The system may be configured to send single or multiple notifications in real time or at predefined times. The system can be configured to deliver the event and content and patients will have the ability to respond as previously described herein.

According to an embodiment of the present invention, the system may be configured to send promotional content along with provider joining events. In this manner, patients can be provided with relevant promotional materials when receiving these events.

Provider Leaving

According to an embodiment of the present invention, the system can send notifications regarding a provider(s) leaving the practice to patients and/or authorized contacts. The system may be configured to send single or multiple notifications in real time or at predefined times. The system can be configured to deliver the event and content and patients will have the ability to respond as previously described herein.

According to an embodiment of the present invention, the system may be configured to send promotional content along with provider leaving events. In this manner, patients can be provided with relevant promotional materials when receiving these events.

Medication Reminders

According to an embodiment of the present invention, the system can send medication reminders (e.g., don't forget to take your blood pressure medicine) to patients and/or authorized contacts at predefined times. The system may be configured to send single or multiple notifications in real time or at predefined times. The system can be configured to deliver the event and content and patients will have the ability to respond as previously described herein.

According to an embodiment of the present invention, the system may be configured to send promotional content along with medication reminder events. In this manner, patients can be provided with relevant promotional materials when receiving these events.

Refill Reminders

According to an embodiment of the present invention, the system can send refill notifications informing patients and/or authorized contacts when the allotted number of refills has expired and an appointment must be scheduled to obtain a new prescription. The system may be configured to send single or multiple notifications in real time or at predefined times. The system can be configured to deliver the event and content and patients will have the ability to respond as previously described herein.

According to an embodiment of the present invention, the system may be configured to send promotional content along with refill reminder events. In this manner, patients can be provided with relevant promotional materials when receiving these events.

Disease Management

According to an embodiment of the present invention, the system can send notifications regarding disease management (e.g., diabetes) to patients and/or authorized contacts. The system may be configured to send single or multiple notifications in real time or at predefined times. The system can be configured to deliver the event and content and patients will have the ability to respond as previously described herein.

According to an embodiment of the present invention, the system may be configured to send promotional content along with disease management events. In this manner, patients can be provided with relevant promotional materials when receiving these events.

Follow-Up

According to an embodiment of the present invention, the system can send notifications regarding follow-up care to patients and/or authorized contacts. The system may be configured to send single or multiple notifications in real time or at predefined times. The system can be configured to deliver the event and content and patients will have the ability to respond as previously described herein.

According to an embodiment of the present invention, the system may be configured to send promotional content along with follow-up events. In this manner, patients can be provided with relevant promotional materials when receiving these events.

Procedures

According to an embodiment of the present invention, the system can send pre- and post-procedure notifications to patients and/or authorized contacts with appointment information (e.g., date/time) and instructions. The system may be configured to send single or multiple notifications in real time or at predefined times. The system can be configured to deliver the event and content and patients will have the ability to respond as previously described herein.

According to an embodiment of the present invention, the system may be configured to send promotional content along with procedure events. In this manner, patients can be provided with relevant promotional materials when receiving these events.

Collections

According to an embodiment of the present invention, the system can send collections notifications to patients and/or authorized contacts. The system may be configured to send single or multiple notifications in real time or at predefined times. The system can be configured to deliver the event and content and patients will have the ability to respond as previously described herein.

Statement of Account

According to an embodiment of the present invention, the system can send notifications to patients and/or authorized contacts stating current patient balance. The system may be configured to send single or multiple notifications in real time or at predefined times. The system can be configured to deliver the event and content and patients will have the ability to respond as previously described herein.

Payment Plan

According to an embodiment of the present invention, the system can send notifications to patients and/or authorized contacts reminding the agreed upon payment arrangement is due. The system may be configured to send single or multiple notifications in real time or at predefined times. The system can be configured to deliver the event and content and patients will have the ability to respond as previously described herein.

Tasks

According to an embodiment of the present invention, the system can create tasks for employees. The system may be configured to send single or multiple notifications in real time or at predefined times. The system can be configured to deliver the event and content and patients will have the ability to respond as previously described herein.

Task events may include any task a provider may want their employees to do, from handling billing or paperwork to cleaning a particular patient room or waiting room. Tasks may be generated and delivered by and through the system. In a preferred embodiment, providers are able to generate these events through the use of remote computing devices (e.g., tablet PCs, smartphones) and have these events generated and delivered to the appropriate employees, contractors or other service provider. One of ordinary skill in the art would appreciate that there are numerous task event types that may be utilized with embodiments of the present invention, and embodiments of the present invention are contemplated for use with any task event type.

New Baby

According to an embodiment of the present invention, the system can send notifications to patients and/or authorized contacts when a baby is born. The system may be configured to send single or multiple notifications in real time or at predefined times. The system can be configured to deliver the event and content and patients will have the ability to respond as previously described herein.

According to an embodiment of the present invention, the system may be configured to send promotional content along with new baby events. In this manner, patients can be provided with relevant promotional materials when receiving these events.

Wellness/Preventive Medicine

According to an embodiment of the present invention, the system can send notifications to patients and/or authorized contacts regarding wellness and preventive medicine. The system may be configured to send single or multiple notifications in real time or at predefined times. The system can be configured to deliver the event and content and patients will have the ability to respond as previously described herein.

According to an embodiment of the present invention, the system may be configured to send promotional content along with wellness/preventative medicine events. In this manner, patients can be provided with relevant promotional materials when receiving these events.

Social Correspondence

According to an embodiment of the present invention, the system can send notifications to patient provided contact list (e.g, birth announcement, baby shower, birthday party). One of ordinary skill in the art would appreciate that there are numerous types of social correspondence event types that may be utilized with embodiments of the present invention, and embodiments of the present invention are contemplated for use with any social correspondence event type. The system may be configured to send single or multiple notifications in real time or at predefined times. The system can be configured to deliver the event and content and provide patients the ability to respond as previously described herein.

According to an embodiment of the present invention, the system may be configured to send promotional content along with social correspondence events. In this manner, patients can be provided with relevant promotional materials when receiving these events.

No-Show

According to an embodiment of the present invention, the system can send notifications to patients and/or authorized contact when the patient has missed a scheduled appointment. The system may be configured to send single or multiple notifications in real time or at predefined times. The system can be configured to deliver the event and content and provide patients the ability to respond as previously described herein. In certain embodiments, the patient may be able to reschedule their missed appointment directly through a response. For instance, the system may be configured to pair no-show event notifications with open appointment events and send both in unison.

According to an embodiment of the present invention, the system may be configured to send promotional content along with no-show events. In this manner, patients can be provided with relevant promotional materials when receiving these events.

Holiday

Users can send holiday greetings to individuals (i.e., patients, authorized contacts). Users can send single or multiple notifications in real time or at predefined times. Users can choose the desired delivery method(s) and content (audio and visual).

According to an embodiment of the present invention, the system can send holiday greetings to individuals (i.e., patients, authorized contacts). The system may be configured to send single or multiple notifications in real time or at predefined times.

According to an embodiment of the present invention, the system may be configured to send promotional content along with holiday events. In this manner, patients can be provided with relevant promotional materials when receiving these events.

According to an embodiment of the present invention, the aforementioned event types are a sampling of the events that the system could be utilized to generate and send. One of ordinary skill in the art would appreciate that there are numerous other types of events that could be utilized with embodiments of the present invention, and embodiments of the present invention are contemplated for use with any type of event.

Forecasting

According to an embodiment of the present invention, the system may be configured to provide a graphical user interface, whereby users may view all scheduled events (or any subset thereof) and take actions on those events. For instance, the system may be configured to display a calendar like interface with each notification placed on the specific time/day it is to be sent. Events that have multiple patients/recipients associated with them may be identified as such (e.g., different color, size, icon).

In this embodiment, the system may provide the user the ability to interact with the displayed events. For instance, a user may be able to add/delete events directly to/from the graphical user interface, add/delete recipients to/from particular events, move events to different times/days and combine events for transmission in unison (i.e., batch transmission). One of ordinary skill in the art would appreciate that there are numerous interactions that may be utilized with embodiments of the present invention, and embodiments of the present invention are contemplated for use with any interaction.

Notification Center

According to an embodiment of the present invention, in conjunction or separately from the forecasting components described above, the system may be configured to allow users to view, sort, and filter past interactions/events. In this manner, the system may allow users to review events/interactions that had already occurred. This may be helpful for accounting/auditing purposes as well as confirmation and tracking of previous events. Advantageously, in particular where promotional materials are sent with events, tracking of patient behaviors/patterns can be viewed over time.

Patient Journal

According to an embodiment of the present invention, in conjunction or separately from the notification center components described above, the system may be configured to allow patients a graphical user interface that is configured to display patient-specific past and future interactions/events (i.e., Patient Journal). In this manner, a patient may be provided clear access to their healthcare records in a graphical manner. In certain embodiments, the patient journal may be configured to track and store specific details associated with each interaction/event. For instance, the system may be configured to store receipts, treatment histories, immunization records and wellness visits so that the patient has access to this data at their convenience. One of ordinary skill in the art would appreciate that there are numerous types of data that may be stored and displayed to the patient via the patient journal, and embodiments of the present invention are contemplated for use with any type of data.

Open Appointments Module

According to an embodiment of the present invention, the system may be configured to provide a graphical user interface that displays all (or some subset thereof) available provider/resource appointment times via a website/portal or other means (i.e., Open Appointment Module). The system may further be configured to provide patients the ability to select and schedule available appointment from providers/resource. The system may be further configured to allow a patient to cancel an appointment they previously made, allowing the system to keep an up to date record of appointment availability.

Waiting List

According to an embodiment of the present invention, the system may be configured to provide users the ability to notify patients who have requested an appointment of open appointments (e.g., cancel/no-show) and patients can respond to accept an open appointment. The first request for a specified appointment would be scheduled for the specified time slot. This system may be configured to use this method in conjunction with the appointment event type as described above.

For example, a patient may call a service provider to schedule an appointment but the service provider does not have anything available until next week and the patient was hoping to get in sooner. The service provider asks if the patient would like to be put on the wait list and the patient agrees. Another patient cancels an appointment for this afternoon and the patient receives one or more of a text, email, or phone call stating the date and time of the newly opened appointment. The patient then is provided ability to accept that appointment.

Library

According to an embodiment of the present invention, the system may be configured to provide a library of content for use with events. The library of content comprises a collection of predefined content (e.g., verbiage, images, sound files, templates) that users can select for use at the interaction level. One of ordinary skill in the art would appreciate that there are numerous types of predefined content that may be utilized with embodiments of the present invention, and embodiments of the present invention are contemplated for use with any type of predefined content.

The system may be configured to allow users to save their customized content to the library for future use. In this manner, users can pre-configure events for future use. Advantageously, routine events (e.g., appointment reminders) can be generated quickly and easily from template events stored in the library. In a preferred embodiment of the present invention, the library may be stored in the data store. In alternative embodiments, the library may be stored locally or remotely (e.g., an application server accessible via the Internet) and provided to the system upon request.

Collection Agency

According to an embodiment of the present invention, users can move past due amounts owed by one or more patients into collections with an outside debt collection agency and provide all relevant data for said patients. The system may be configured to provide only the relevant data allowed by a particular jurisdiction. Since it is intended that the system be capable of storing and utilizing personal and private health records and other healthcare data related to the patients, preferred embodiments of the system may be configured to identify relevant collections data and send only the relevant collections data to the collection agency or the systems thereof. This process may be fully automated, whereby past due amounts are automatically sent to a collections agency, based upon some predetermined event (e.g., 90-days overdue, returned check). Advantageously, the system provides users the ability to automate their collections practices and administer collections in an unbiased manner.

Exemplary Embodiments

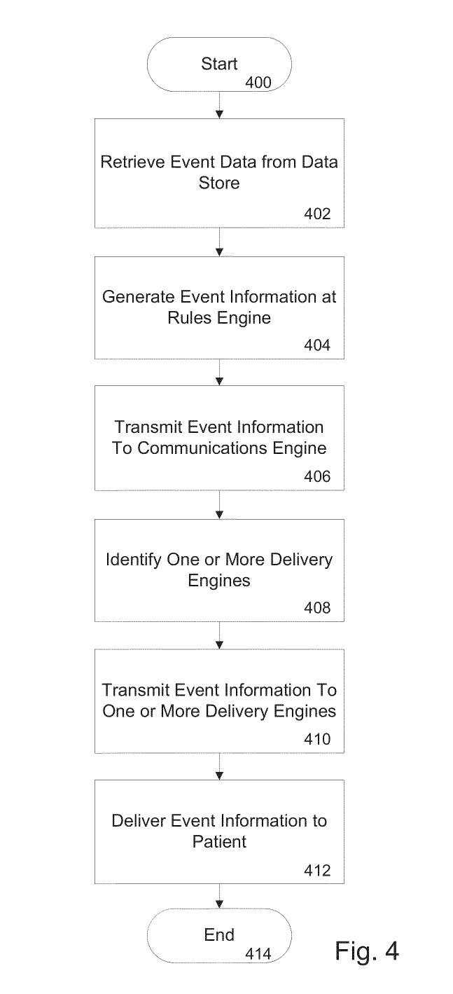

The following is an exemplary embodiment of a method for generating and delivering an event, as shown in FIG. 4. At step 400, the process starts with the generation of an event. The event may have been manually requested by a provider or it may have been automatically generated by a rules engine based on rules/information previously inserted into the system by the provider.

At step 402, the rules engine will identify the event type, recipient and other information associated with the event request. During this step, the rules engine may engage with a data store in order to retrieve stored portions of the information not provided in the event request.

At step 404, the rules engine will utilize the information provided in the event request as well as information retrieved from the data store to generate event information. Event information comprises all the necessary information required to effect the delivery of an event.

At step 406, the rules engine will transmit the event information to a communications engine. The communications engine may be specified by information contained in the event information or otherwise stored at the rules engine or data store. In a preferred embodiment, the rules engine will be configured to communicate with a specific communications engine and that communications engine is aware of the rules engine and configured to receive event information from the rules engine.

At step 408, the communications engine has received the event information from the rules engine. The communications engine will then use information stored in the event information, stored in the communication engine (e.g., predefined delivery settings) or provided by the rules engine to identify the appropriate delivery engines for the event information.

At step 410, the communications engine effects the transmission of the event information to one or more delivery engines. It may be necessary in certain cases to deliver event information to multiple delivery engines in the case where delivery is requested in multiple formats. For instance, if delivery in printed format as well as e-mail is requested, the communications engine may be configured to provide the event information containing a request for printed delivery to an application programming interface (API) of a delivery engine with delivery means for printing and sending printed materials as well as send the event information to an API of a delivery engine capable of transmitting events in e-mail format to a patient.

At step 412, the one or more delivery engines effect the delivery of the event to the patient. As noted above, this can be done in a variety of formats in a variety of manners. At step 414, the process terminates. Alternatively, one or more of the delivery engines may remain open for response communications from the patient.

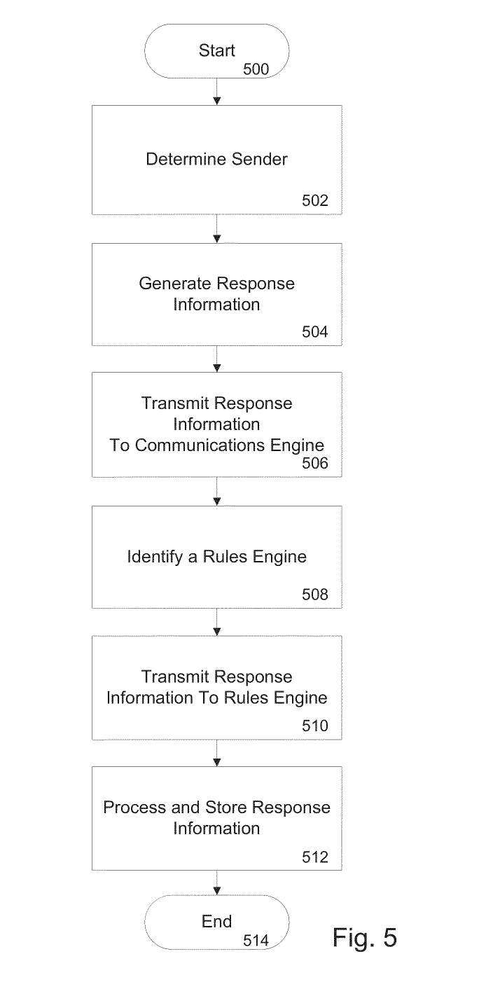

The following is an exemplary embodiment of a method for receiving responses from patients related to an event (or, in alternative embodiments, unrelated to a previous event), as shown in FIG. 5. At step 500, the process starts with the receipt of a patient response at a delivery engine. The patient response is generally received in response to an event previously sent to the patient by the system.

At step 502, the delivery engine receiving the response will first attempt to determine the sender of the response. This can be done in various manners, depending on the response format. For instance, if the response is an e-mail, the delivery engine may use the response e-mail address to identify the appropriate provider/rules engine to send the response to. One of ordinary skill in the art would appreciate that there are numerous methods for identifying senders, and embodiments of the present invention are contemplated for use with any method for identifying senders.

At step 504, the delivery engine will generate response information related to the response. The response information may include relevant data, such as response time, date, identifying information, content and intended recipient. One of ordinary skill in the art would appreciate that there are numerous types of relevant data that may be utilized with embodiments of the present invention, and embodiments of the present invention are contemplated for use with any type of relevant data.

At step 506, the delivery engine transmits the response information to a communications engine that it knows is communicatively connected to the appropriate rules engine. In this manner, the delivery engine effects the transmission of the response information only to a communications engine it knows can deliver the response information to the rules engine intended to receive the response information.

At step 508, the communications engine has received the response information from the delivery engine. The communications engine will then use information stored in the response information, stored in the communication engine (e.g., predefined delivery settings) or provided by the delivery engine to identify the appropriate rules engine for the response information.

At step 510, the communications engine effects the transmission of the response information to the appropriate rules engine.

At step 512, the rules engine processes the response information received from the communications engine. If the response is of a type that the sender is authorized to make and is of a format the rules engine understands, the response may be immediately processed by the rules engine and any changes associated with the response may be stored in the data store or in the rules engine as appropriate. If the response requires permission that is not confirmed by the response information or contains content that is not otherwise automatically able to be processed by the rules engine, an alert may be presented to the service provider to confirm information or to manually effect the changes present in the response.

At step 514, the process terminates. Alternatively, one or more of the delivery engines may remain open for response communications from the patient.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A computer implemented system for providing patient relationship management, the system comprising:
a rules engine comprising computer-executable code stored in non-volatile memory, a data store and a rules engine communications means;
a communications engine comprising computer-executable code stored in non-volatile memory and a communications engine communications means,
wherein said rules engine communications means is configured to communicate data to said communications engine communications means; and
one or more delivery engines comprising computer-executable code stored in non-volatile memory, one or more delivery means and a delivery engine communications means,
wherein said communications engine communications means is configured to communicate data to said delivery engine communications means of said one or more delivery engines,
wherein said rules engine is configured to transmit event information, via said rules engine communications means to said communications engine communications means,
wherein said communications engine is configured to communicate said event information to one or more of said one or more delivery engines, and
wherein each of said one or more delivery means receiving said event information is configured to process said event information into a processed event and effect delivery of said processed event.

2. The computer implemented system of claim 1, wherein said event information includes information related to an individual.

3. The computer implemented system of claim 1, wherein said communications engine communications means is configured to communicate data to said delivery engine communications means.

4. The computer implemented system of claim 1, wherein at least one of said delivery engine communications means is configured to communicate data to said communications engine communications means.

5. The computer implemented system of claim 4, wherein at least one of said delivery engine communicates a delivery confirmation to said communications engine.

6. The computer implemented system of claim 5, wherein said communications engine communicates said delivery confirmation to said rules engine.

7. The computer implemented system of claim 6, wherein said rules engine processes said delivery confirmation and stores related data in said data store.

8. A computer implemented method for providing patient relationship management, the method comprising the steps of:
receiving an event request at a rules engine comprising computer-executable code stored in non-volatile memory, a data store and a rules engine communications means;
retrieving data associated with said event request from said data store;
generating, at said rules engine, event information from said event request and said data associated with said event request;
transmitting, via said rules engine communications means, said event information to a communications engine comprising computer-executable code stored in non-volatile memory and a communications engine communications means;
receiving said event information at said communications engine communications means;
determining, at said communications engine, one or more delivery engines to communicate said event information to, wherein each of said delivery engines comprises computer-executable code stored in non-volatile memory, one or more delivery means and a delivery engine communications means;
transmitting, via said communications engine communications means, event information to one or more of said one or more delivery engines;
processing, at one or more of said one or more delivery engines, said event information into a processed event; and
delivering, via said one or more delivery means, said processed event.

9. The computer implemented method of claim 8, wherein said event information includes information related to an individual.

10. The computer implemented method of claim 8, further comprising the step of communicating a delivery confirmation from one or more of said one or more delivery engines to said communications engine.

11. The computer implemented method of claim 10, further comprising the step of communicating said delivery confirmation from said communications engine to said rules engine.

12. The computer implemented system of claim 11, further comprising the step of processing said delivery confirmation.

13. The computer implemented system of claim 11, further comprising the step of storing said delivery confirmation in said data store.

14. A computer implemented method for providing patient relationship management, the method comprising the steps of:
receiving an event response at a delivery engine comprising computer-executable code stored in non-volatile memory and a delivery engine communications means;
generating, at said delivery engine, an event response communication based at least in part on said event response;
transmitting, via said delivery engine communications means, said event response communication to a communications engine comprising computer-executable code stored in non-volatile memory and a communications engine communications means;
receiving said event response communication at said communications engine communications means;
determining, at said communications engine, one or more rules engines to communicate said event response communication to, wherein each of said rules engines comprises computer-executable code stored in non-volatile memory, a data store and a rules engine communications means;
transmitting, via said communications engine communications means, event response communication to one or more of said one or more rules engines;
processing, at one or more of said one or more rules engines, said event response communication into a processed response; and
storing, in said data store, said processed event.

15. The computer implemented method of claim 14, further comprising the step of communicating a response delivery confirmation from one or more of said one or more rules engines to said communications engine.

16. The computer implemented method of claim 15, further comprising the step of communicating said response delivery confirmation from said communications engine to said delivery engine.

17. The computer implemented system of claim 14, further comprising the step of processing said response delivery confirmation.

18. The computer implemented system of claim 14, further comprising the step of delivering said response delivery confirmation to a patient.
